(19) United States
(12) Patent Application Publication
(10) Pub. No.: US 2009/0245532 A1
(43) Pub. Date: Oct. 1, 2009

(54) HEADSET

(75) Inventors: Ernst HUPKES, Kampen (NL); Ido Gert DE HAAN, NP Assen (NL)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/055,422

(22) Filed: Mar. 26, 2008

(51) Int. Cl. H04R 1/10; H04B 7/00

(52) U.S. Cl. 381/74; 455/41.3

(57) ABSTRACT

The invention relates to a headset comprising a housing with an earphone, said headset being arranged for being positioned close to a person's left ear or right ear during use and being arranged for cooperating with a further device. According to the invention, said headset comprises an accelerometer arranged for detecting movements of the headset corresponding to handwriting and for providing output signals corresponding to such movements, said accelerometer cooperating with a recognition unit being arranged for converting said output signals to characters, symbols or similar information to be transmitted to said further device.

### FIELD OF THE INVENTION

The present invention relates to a headset comprising a housing with an earphone, said headset being arranged for being positioned close to a person's left ear or right ear during use and being arranged for cooperating with a further device.

### BACKGROUND ART

Today, there exist many types of electronic devices such as mobile telephones, media players, palmtop computers etc. Mobile devices such as mobile telephones, for example, are normally equipped with a function called short message service (also known as “sms”, or “teletext”), i.e. a communications protocol forming part of the GSM system and allowing transmission of relatively short text messages between such mobile telephones.

According to known technology, such sms messages (or “text messages”) can be composed and entered by the user into the mobile telephone by using the keypad of the telephone. More precisely, characters such as letters, digits and other symbols are entered into the telephone manually by pressing the corresponding keys on the keypad.

An alternative way of entering characters forming an sms message is by using a so-called stylus, i.e. a pointed, pencil-like writing tool which is used in many of today's mobile telephones for entering characters by “writing” on a touch sensitive screen forming part of the telephone. Today, such a combination of a stylus and a “writing pad” in the form of a touch sensitive screen is relatively common and can often be regarded as more user-friendly than entering characters manually via a keypad.

Even though the above-mentioned known methods of entering information are relatively straight-forward for a user of a mobile device such as a mobile telephone, there is an increasing demand in the mobile telephone market for even more easy, quick and user-friendly ways of operating a mobile telephone.

In particular, with regard to sms messages, there is a need to simplify the user interaction with the mobile telephone and there is a need for faster, easier and more intuitive ways of composing sms messages, mms messages and e-mail messages, by means of easy and convenient input methods. There is also a need for increased speed when entering information, for example relating to an sms message.

### SUMMARY OF THE INVENTION

With the above and following description in mind, an aspect of certain embodiments of the present invention is to provide a headset for example for handheld, portable devices such as a mobile telephone, in which the above-mentioned drawbacks can be overcome, and which can be used for providing a more user-friendly way of composing sms messages and for inputting information than previously known.

By means of the invention, there is provided a headset of the kind mentioned initially which comprises an accelerometer arranged for detecting movements of the headset corresponding to handwriting and for providing output signals corresponding to such movements, said accelerometer cooperating with a recognition unit being arranged for converting said output signals to characters, symbols or similar information to be transmitted to said further device.

The invention leads to certain advantages. Primarily, it can be noted that it provides a more simple user interaction and that it fulfills the need for faster, easier and more intuitive inputting of information, such as composing of sms messages and similar.

According to an embodiment of the invention, the headset may be shaped generally as a pencil-like object having a pointed end section.

Furthermore, headset is suitably associated with a further device in the form of a mobile telephone, portable computer or similar communication device. Also, said output signals are suitably used for inputting characters forming sms messages, mms messages, e-mail message or the like.

According to an embodiment of the invention, the headset may be associated with a further device in the form of a game unit, a media player, a DVD player or a similar device. In such case, said output signals can be used for inputting control commands or instructions to said further device, thereby controlling the operation of said further device.

Furthermore, the headset can be arranged for communicating with said further device via a wireless connection. The wireless connection is suitably arranged in accordance with the Bluetooth wireless protocol. According to a further embodiment, the headset may be arranged for communicating with the further device via a wired connection.

Also, according to an embodiment, the housing may have a generally elongated shape so as to allow positioning of the earphone close to a user's ear and to allow positioning of the microphone close to a user's mouth.

Furthermore, it should be emphasised that the term comprising or comprises, when used in this description and in the appended claims to indicate included features, elements or steps, is in no way to be interpreted as excluding the presence of other features elements or steps than those expressly stated.

### BRIEF DESCRIPTION OF THE DRAWINGS

The invention will now be described in more detail with reference to certain embodiments and to the attached drawings, in which:

FIG. 1 shows a schematic view of a mobile telephone communicating with a headset which is designed according to the principles of the invention;

FIG. 2 is a schematical block diagram of a headset and a mobile telephone of the above-mentioned type; and

FIG. 3 is a perspective view of a user using the invention.

### DETAILED DESCRIPTION OF A PREFERRED EMBODIMENT

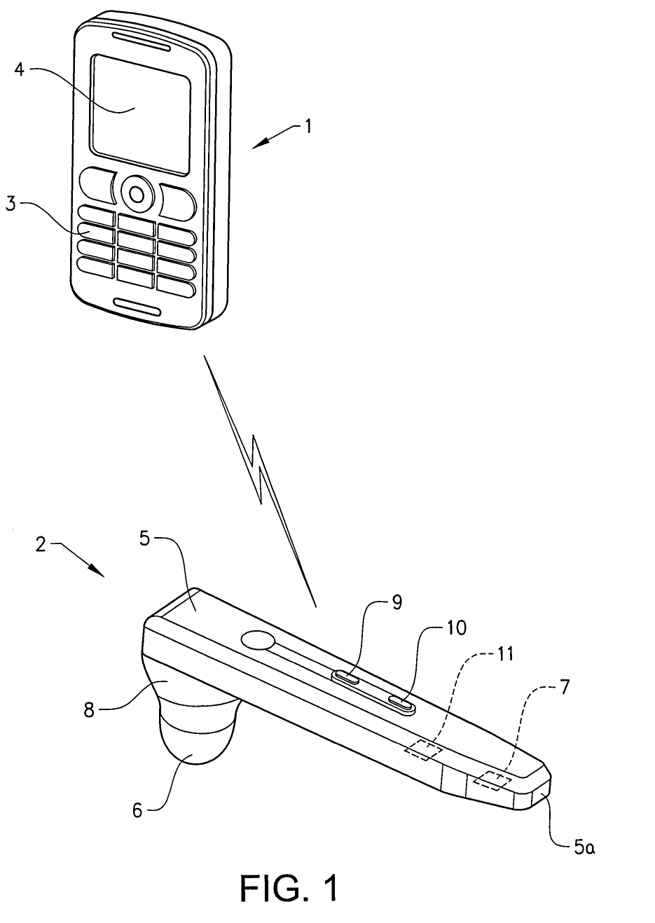

With reference to FIG. 1, there is shown a schematic view of a handheld, portable mobile telephone 1 being associated with and communicating with a headset 2. It should be mentioned that the invention is not limited to be used in mobile telephones only. The headset according to the invention may equally well be used, for example, together with a further device in the form of a palmtop computer, an electronic game unit, a media player (for example a so-called mp3 player), a smartphone, a handheld DVD player, a pager and similar devices.

In a conventional manner, the mobile telephone 1 is provided with a keypad 3 and a display 4. The mobile telephone 1 is also arranged for communicating with the headset 2. As indicated schematically in FIG. 1, the communication between the mobile telephone 1 and the headset 2 may be wireless, by means of a wireless communications protocol such as for example the Bluetooth wireless protocol. The manner in which different units communicate via the Bluetooth protocol is previously known as such, and for this reason it will not be described in detail here.

It can furthermore be noted that the principles of the present invention can also be implemented in headsets being connected to a further device via a wired communication line, i.e. the invention is not limited to wireless communication between a mobile unit and a headset.

As shown in FIG. 1, the headset 2 comprises a housing 5 which is suitably elongated, i.e. having a design with notably more length than width. Furthermore, the housing 5 carries an earphone 6, i.e. a small loudspeaker unit, and a microphone 7. The earphone 6 is placed at the end section of a protruding part 8 which is arranged for being positioned in the ear of a person (not shown) who is using the headset 2. Also, the microphone 7 is arranged for being positioned relatively close to the person's mouth during use.

The headset 2 as shown in FIG. 1 is suitably designed to be supported on a person's ear just by positioning the protruding part 8 with the earphone 6 inside the ear. However, although not shown in FIG. 1, the headset 2 may comprise a fastening element, for example in the form of an ear loop device, for fastening the entire headset more tightly on either one of a person's left or right ear (not shown).

The headset 2 is shown in FIG. 1 in a slightly simplified manner. It is apparent that a headset 2 such as the one shown in FIG. 1 may comprise user interface controls such as buttons, switches and similar components. As an example of such a user interface control, a first button 9 and a second button 10 are shown. The buttons 9, 10 are examples of controls forming part of a user interface, or a man-machine interface (MMI). According to the embodiment shown, the first button 9 can be used for decreasing the volume in the earphone 6, and the second button 10 can be used for increasing the volume in the earphone 6.

As mentioned initially, in the field of handheld and mobile devices such as mobile telephones, there is an need for increased user-friendliness and speed for example when entering information for an sms message. Existing methods, for example entering such information via a keypad or by means of a stylus cooperating with a touchscreen, are not always sufficiently easy and quick to use. It can also be said that today, most mobile phones do not have a touch sensitive screen, which means that intuitive writing with a stylus is not accessible for many users.

With the above in mind, it is an important feature of the invention that the headset 2 is arranged as a writing tool for inputting information to be used in the mobile telephone 1. For example, such information can be used in a short message service function (hereinafter referred to as an “sms” function). For this reason, the headset 2 according to the embodiment shown in FIG. 1 is provided with an accelerometer for identifying movements of the headset 2 corresponding to writing-like movements and for transforming such detected movements into characters, symbols or other information to be fed into the mobile telephone 1 and used for example for the sms service. Such an accelerometer is indicated schematically by means of reference numeral 11 in FIG. 1.

According to an embodiment of the invention, the housing 5 is shaped generally as a pen, i.e. having an elongated design with a pointed end portion 5a similar to the tip of a pencil. However, the invention is not limited to any particular type of shape or design of the housing 5.

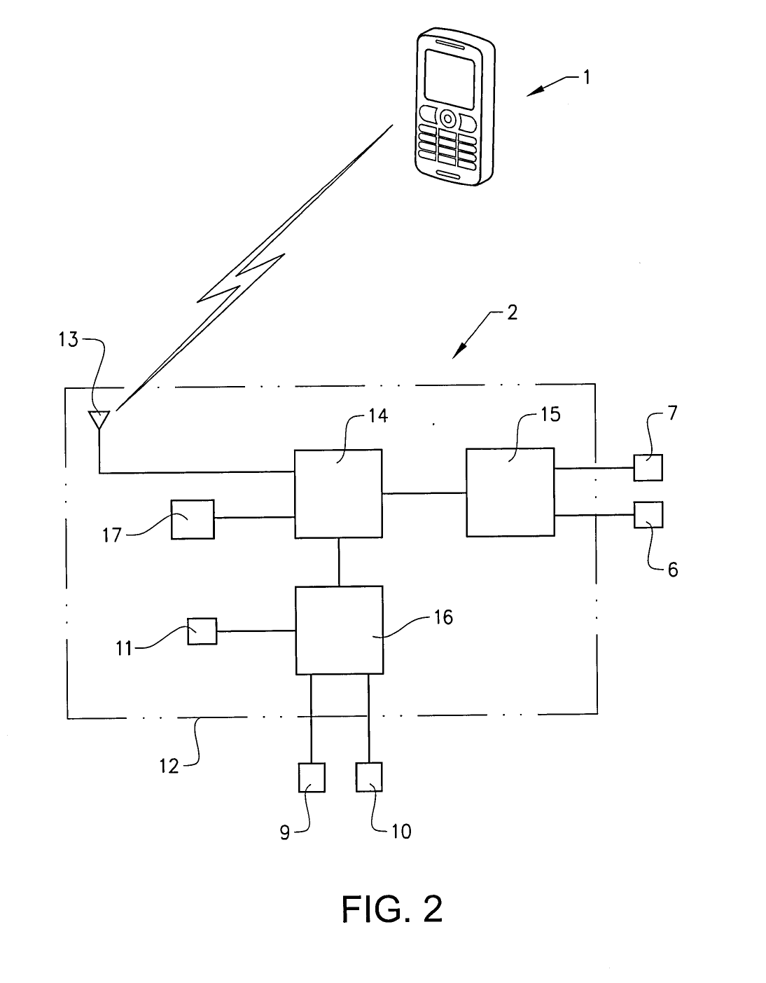

The manner in which the accelerometer 11 is arranged in order to use the entire headset 2 as a writing tool will now be described with further reference to FIG. 2, which is a block diagram of a number of components forming part of the headset 2 and the mobile telephone 1 of the above-mentioned type.

FIG. 2 shows a block diagram of a headset control unit 12 which is preferably mounted as an integrated unit inside the housing 5 of the headset 2. The control unit 12 comprises an antenna 13 which is arranged for communicating with the mobile telephone 1, suitably via the Bluetooth wireless protocol as mentioned above. The antenna 13 is connected to a microprocessor 14 arranged for controlling the transmission of signals between the headset 2 and the mobile telephone 1. Furthermore, the microprocessor 14 is connected to an audio interface 15, arranged for receiving audio signals from the microphone 7 and for feeding audio signals to the earphone 6. The microprocessor 14 is also connected to an I/O (input/output) unit 16, to which the above-mentioned two buttons 9, 10 are connected.

Furthermore, the above-mentioned accelerometer 11 is connected to the I/O unit 16. The invention is based on the principle that the accelerometer 11 is used for providing input signals indicating movements of the housing 5 along a generally horizontal plane (x and y directions) or alternatively movements both along a horizontal plane and also along a vertical direction (z direction), i.e. transversal to both the x and y directions. Such signals can be used in order to detect a pattern of movement of the headset 2. More precisely, when a user moves the headset 2 in a fashion similar to writing with a pencil, the accelerometer 11 will output a signal corresponding to the direction of movement and the acceleration of the movement. This signal is fed to the microcontroller 14 and is used to recognize characters, numbers and other symbols corresponding to such “writing” movements of the headset 2.

In order to recognize and identify which symbols correspond to the movements of the headset 2, the microcontroller 14 is suitably connected to a character recognition unit 17 for translating the signals from the accelerometer 11 corresponding to the movements of the headset 2 (i.e. the “writing” by means of the headset 2) into corresponding symbols and other pieces of information.

Consequently, the microcontroller 14 of the headset 2 is arranged for outputting and transmitting to the mobile telephone 1 signals corresponding to information being formed by the characters and symbols detected from the movements of the headset 2. For this reason, the mobile telephone 1 is arranged for receiving the signals from the headset 2, preferably via the Bluetooth protocol as described above. The signals from the headset 2 are used as input information in the form of characters or symbols to various functions of the mobile telephone 1. For example, the input information can be used for composing an sms message, an mms message, an e-mail or similar.

The accelerometer 11 can be of conventional type and being, for example, of capacitive, piezoelectric or piezoresistive type. An accelerometer to be used within the frame of this invention is generally arranged to sense and convert an external acceleration force acting on the housing 5 and being detected from a motion. Such motion would result from movement of the housing 5 in a manner similar to writing with a pencil. Due to the shape of the housing (cf. FIG. 1), it can be held with a grip just like a pencil so that the end part 5a of the housing 5 would simulate a tip of a pencil. When writing the message (such as when composing an sms message), the user will hold the headset in one hand and have it positioned in a hand similar to a ballpoint pen.

According to the principles of this invention, an accelerometer of the 2D type, i.e. indicating movements only in a plane (above defined as an x-y plane), can normally be used. In such a case, the writing movements of the headset 2 along a generally horizontal plane (not shown) can be detected. Such a situation would correspond to a user “writing” with the headset 2 on a surface such as a table or a separate writing pad. As an alternatively, the mobile telephone 1 can be equipped with a screen having dimensions and a design allowing it to be used as a writing pad. This means that the user would use the headset 2 for writing movement directly on such a screen. Alternatively, the accelerometer can be of the 3D type, which means that also movement in a z direction, i.e. “up and down”, can be detected.

By means of detecting acceleration in each of the two or three axes (depending on whether the accelerometer is of the 2D or 3D type), the headset will be able to identify individual characters based on the movements of the headset made by the user.

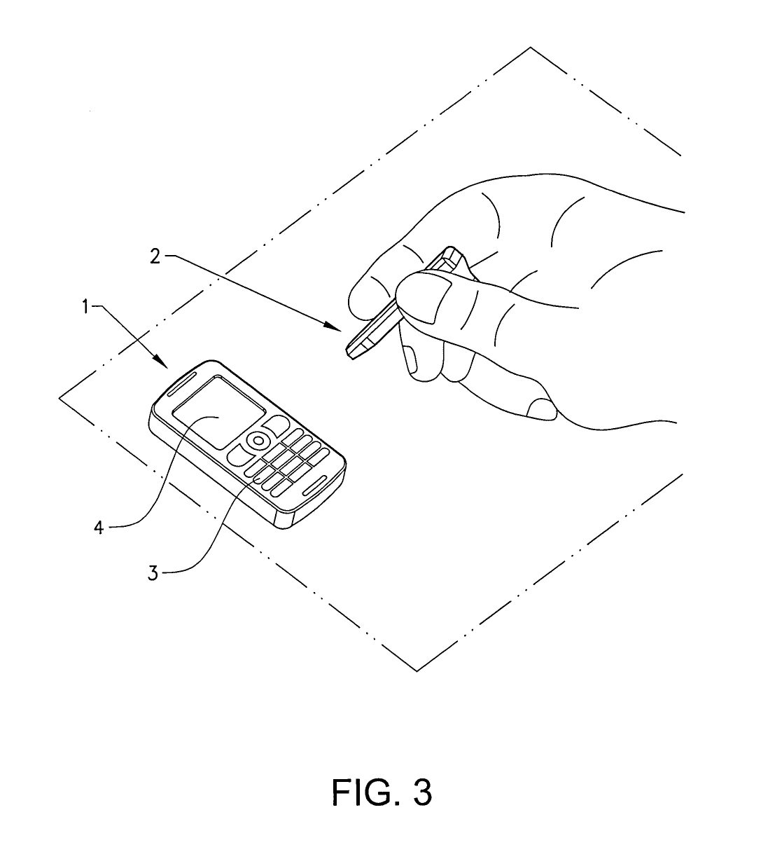

FIG. 3 is a perspective view of a headset 2 according to an embodiment of the invention, being in use. Accordingly, FIG. 3 shows the headset 2 being held in the hand of a user and being gripped generally in the same manner as a pencil. As described above, the headset 2 is suitably held so that it is pointed towards a surface on which the mobile telephone 1 is placed.

As described above, the headset 2 is arranged for detecting and converting writing-like movements into characters and symbols. This can be achieved if the headset 2 is used to “write” onto a surface, as shown in FIG. 3, or if it is used for making such movements in the air, i.e. without contacting any surface. Alternatively, the headset 2 can also be used for writing on a surface such as a screen on a mobile telephone.

While composing messages as described above, the characters are suitably shown in real-time on the display 4 of the mobile telephone 1 (e.g. in the SMS composing window).

In summary, the invention is based on the concept that the headset is used as a writing device which can convert the motion of writing-like movements into characters and symbols to be used as input information to a mobile unit such as a mobile telephone. Such information can be used for example in an sms message, an mms message or an e-mail message. The information can also be used for example for entering information via a web browser.

However, the information is not only intended to be in the form of characters and symbols; the invention can also be used with a further device in the form or a game unit, a media player or the like. In such cases, the information having been detected from the “writing” movement can also be used for example for inputting commands or instructions in games or for inputting instructions to a media player (in order to select a particular music track, for example). In this manner, a device such as a game unit or a media player can be controlled by means of writing-like movements of the headset.

It should be mentioned that the inventive concept could be implemented where a user would write on a surface or in-the-air. If a surface is used, the invention could be implemented generally independently of which type of surface is used.

Generally, the invention is useful for all types of electronic devices which are associated with or connected to headsets and having controls for inputting characters and symbols, and also inputting commands or making selections related to the operation of the device.

The invention is not limited to the embodiment described above, but may be modified without departing from the scope of the claims below. For example, the invention can suitably be used in portable, handheld terminals such as mobile telephones, but is not limited to this type of use only but can be used in media players, computers, smartphones, game units, DVD players, pagers and similar devices. In fact, the invention can be used in generally any devices or terminals communicating with a headset and where there is a need for inputting information by means of movement similar to hand-writing.

The invention can be applied in headsets being arranged for wireless or wired communication with a further unit (such as the mobile telephone described above).

In the case of wireless communication, it can be noted that the invention can be implemented using Bluetooth technology or any other type wireless technology.

Furthermore, it should be mentioned that the interpretation of the movement data, as detected by the accelerometer 11, can be done by algorithms inside the headset control unit 12, i.e. in the recognition unit 17 but can also be done by algorithms in the mobile telephone 1.

According to an alternative embodiment of the invention, it can be implemented in a headset of a type which only comprises an earphone, i.e. which is not provided with a microphone. Such a headset may be used together with a game unit, a media player or an FM radio, for example, where there normally is no need for inputting audio signals via a microphone in the headset.

1. A headset comprising a housing with an earphone, said headset being arranged for being positioned close to a person's left ear or right ear during use and being arranged for cooperating with a further device, wherein said headset furthermore comprises an accelerometer arranged for detecting movements of the headset corresponding to handwriting and for providing output signals corresponding to such movements, said accelerometer cooperating with a recognition unit being arranged for converting said output signals to characters, symbols or similar information to be transmitted to said further device.

2. A headset according to claim 1, wherein said housing is shaped generally as a pencil-like object having a pointed end section.

3. A headset according to claim 1, wherein the headset is associated with a further device in the form of a mobile telephone, portable computer or similar communication device, wherein said output signals are used for inputting characters forming sms messages, mms messages, e-mail message or the like.

4. A headset according to claim 1, wherein the headset is associated with a further device in the form of a game unit, a media player, a DVD player or a similar device, wherein said output signals are used for inputting control commands or instructions to said further device, thereby controlling the operation of said further device.

5. A headset according to claim 1, wherein the headset is arranged for communicating with said further device via a wireless connection.

6. A headset according to claim 5, wherein the wireless connection is arranged in accordance with the Bluetooth wireless protocol.

7. A headset according to claim 1, wherein the housing has a generally elongated shape so as to allow positioning of the earphone close to a user's ear and to allow positioning of the microphone close to a user's mouth.

8. A headset according to claim 1, wherein the headset is arranged for communicating with the further device via a wired connection.
